(19) United States
(12) Patent Application Publication
(10) Pub. No.: US 2004/0003753 A1
(43) Pub. Date: Jan. 8, 2004

(54) Ink for stencil printing

(75) Inventors: Hiroshi Matsuda, Ibaraki-ken (JP); Seiki Tamura, Ibaraki-ken (JP)

Correspondence Address: Kendrew H. Colton, FITCH, EVEN, TABIN & FLANNERY, Suite 401L, 1801 K Street, N.W., Washington, DC, 20006-1201, US

(73) Assignee: Riso Kagaku Corporation, Tokyo (JP)

(21) Appl. No.: 10/601,564

(22) Filed: Jun. 24, 2003

(30) Foreign Application Priority Data
Jun. 25, 2002 (JP) 2002-184535

(51) Int. Cl. C09D 11/00

(52) U.S. Cl. 106/31.26; 106/31.78; 106/31.65

(57) ABSTRACT

An ink for stencil printing is provided, which is improved in pigment dispersibility, free from pigment aggregation at the time of emulsification, and excellent in emulsion stability during storage. The ink comprises a water-in-oil emulsion having 10 to 50 wt % of an oil phase and 90 to 50 wt % of a water phase, wherein the oil phase contains, as a pigment, at least a copper phthalocyanine pigment treated with a specific copper phthalocyanine derivative. The treated pigment can be contained at a concentration of 0.5 wt % or more based on the total weight of the ink. It is desirable that the copper phthalocyanine pigment is treated with the specific copper phthalocyanine derivative of 0.01 to 50 wt %, preferably 2 to 20 wt % based on the weight of the pigment. The particle size of the primary particles of the pigment is preferably in a range of 40 to 360 nm.

The present invention relates to an ink for stencil printing, which contains a copper phthalocyanine pigment singly or in combination with another pigment.

In stencil printing, an ink is passed from one side to the other side of a perforated stencil sheet through perforations thereof, for printing on a printing medium such as paper. In recent years, rotary stencil printing machines are controlled by means of microcomputers and the like. Therefore, stencil-making and printing can be performed with ease, and such machines become popular for office use.

Conventional inks used for stencil printing are generally water-in-oil emulsion inks. It can happen that emulsion inks are exposed to high temperatures during storage and transport, thereby causing problems in stability of the inks.

Copper phthalocyanines are generally used as pigments for blue emulsion inks. Copper phthalocyanines have many crystal forms or modifications which are identified by means of X-ray diffraction or infrared absorption spectrum. For stencil printing, α-copper phthalocyanine, β-copper phthalocyanine and ε-copper phthalocyanine have been often used.

Alpha (α)-copper phthalocyanine is reddish blue and has a high tinting strength (C.I. Pigment Blue 15). β-copper phthalocyanine is freshly greenish blue, and available in a non-cohesive type that is obtained by treating the surfaces of its particles with a surfactant, resin, copper phthalocyanine derivative and the like (C.I. Pigment Blue 15:4), as well as a non-treated type (C.I. Pigment Blue 15:3). ε-copper phthalocyanine (C.I. Pigment Blue 15:6) is more reddish blue than α-copper phthalocyanine and has a very high tinting strength.

However, these crystal forms are changed to each other, depending on several conditions. α-form and ε-form tend to be changed to β-form in the presence of aromatic organic solvents or heat, thereby causing crystal growth and crystal transfer and declining in tinting strength or changing in color hue.

JP-A-6-172693 proposes to use β-copper phthalocyanine (C. I. Pigment Blue 15:3) in combination with α-copper phthalocyanine that is reddish blue and excellent in tinting strength (C. I. Pigment Blue 15). This takes advantage of the crystalline form of β-copper phthalocyanine, which is thermodynamically most stable, and thus can inhibit the crystal growth and crystal transfer of the pigment in the oil phase.

However, though β-copper phthalocyanine does not show either crystal growth or crystal transfer in a state where it is dispersed in an oil phase, it has problems such that in dispersion step for preparing an emulsion ink, dispersion failure due to roll mill seizure or the like occurs, and in emulsification step, aggregation occurs, thereby lowering the tinting strength of the ink remarkably.

Furthermore, these phenomena also occur in the case where β-copper phthalocyanine is used together with other pigments, and occur more remarkably when concentration of β-copper phthalocyanine is higher.

Therefore, an emulsion ink for stencil printing, which is good in pigment dispersibility, free from pigment aggregation at the emulsification step and excellent in emulsion stability during storage, is demanded.

The object of the present invention is to provide an emulsion ink for stencil printing, which is good in pigment dispersibility, free from pigment aggregation at the time of emulsification and excellent in emulsion stability during storage.

According to the present invention, the aforesaid object can be achieved by an ink for stencil printing, comprising a water-in-oil emulsion having 10 to 50 wt % of an oil phase and 90 to 50 wt % of a water phase, wherein the oil phase contains, as a pigment, at least a copper phthalocyanine pigment treated with a copper phthalocyanine derivative represented by the following general formula (I):

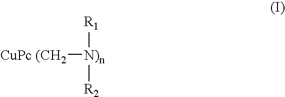

wherein CuPc represents a copper phthalocyanine residue; R₁ and R₂ independently represent a hydrogen atom, alkyl group with 1 to 5 carbon atoms, alkoxyalkyl group with 3 to 6 carbon atoms, or cycloalkyl group with 6 to 8 carbon atoms; and n is an integer of 1 to 6.

It is considered that the copper phthalocyanine derivative is anchored to the surface of particles of the copper phthalocyanine pigment with the phthalocyanine skeleton portion of the derivative being firmly adsorbed or π-bonded to the surface of the pigment particles, and thus the end amino groups of the derivative are oriented outwardly, thereby preventing aggregation of copper phthalocyanine pigment particles in the oil phase of the ink effectively. For this reason, the present invention can provide an emulsion ink which is excellent in pigment dispersibility, free from pigment aggregation at an emulsification step and high in storage stability, compared with the case where a copper phthalocyanine pigment surface-treated with other surfactants or a non-treated copper phthalocyanine pigment is used.

This invention is described below in more detail.

The ink for stencil printing of the present invention is a water-in-oil emulsion consisting of 10 to 50 wt %, preferably 30 to 40 wt % of an oil phase and 90 to 50 wt %, preferably 70 to 60 wt % of a water phase, wherein the total of the oil phase and the water phase is 100 wt %.

The oil phase includes a pigment, organic solvent (oil ingredient), resin, emulsifier and the like. Furthermore, the water phase includes water, electrolyte, antiseptic and antifungal agent, antioxidant, water evaporation preventive, water-soluble polymer and the like. As these ingredients, those which do not inhibit formation of an emulsion should be selected.

The pigment must be constituted by at least a copper phthalocyanine pigment treated with the above-mentioned copper phthalocyanine derivative. The copper phthalocyanine pigment to be treated with the copper phthalocyanine derivative can be any one of α-, β- and ε-copper phthalocyanines, but is preferably β-copper phthalocyanine.

The particle size of the primary particles of the copper phthalocyanine pigment that has been treated with the copper phthalocyanine derivative is preferably within a range of 40 to 360 nm, more preferably 60 to 120 nm, in view of pigment dispersibility and emulsification property.

The copper phthalocyanine pigment that has been treated with the copper phthalocyanine derivative is contained at a concentration of preferably 0.5 wt % or more, more preferably 1.0 to 8.0 wt % based on the ink. When the treated copper phthalocyanine pigment content is in the above-mentioned range, preferred results can be obtained in terms of dispersibility and non-cohesiveness of pigments, storage stability of inks, and the like.

Preferred copper phthalocyanine derivatives include those represented by the formula (I), where R₁ and R₂ independently represent a hydrogen atom or alkyl group with 1 to 3 carbon atoms, and n is 1 to 3. Examples of particularly preferred copper phthalocyanine derivatives are aminomethyl copper phthalocyanine, dimethylamino copper phthalocyanine, diethylamino copper phthalocyanine, etc. The copper phthalocyanine derivatives can be produced according to the method described in JP-A-10-1619. Furthermore, the above-mentioned derivatives can be used singly or as a mixture of two or more.

The method for treatment of the copper phthalocyanine pigment with the copper phthalocyanine derivative is not limited to any specific method. For example, in the course of a process for producing any of various purified copper phthalocyanines, the copper phthalocyanine derivative can be added in a step of dry-grinding a crude copper phthalocyanine, or in a step where a crude copper phthalocyanine that has been dry-ground is perfectly converted into β-crystal form in an organic solvent. It is considered that the copper phthalocyanine derivative is, at this moment, adsorbed by or π-bonded to the surface of the copper phthalocyanine pigment, utilizing the phthalocyanine skeleton portion of the derivative as an anchor, and thus the end amino groups of the derivative are turned outwardly.

In the treatment, it is considered that one to six molecules of the copper phthalocyanine derivative are bonded to one molecule of the copper phthalocyanine pigment. Usually, it is desirable to use the copper phthalocyanine derivative in a range of 0.01 to 50 wt %, preferably 2 to 20 wt % based on the weight of the copper phthalocyanine pigment.

The oil phase of the ink of this invention may contain pigments other than the copper phthalocyanine pigment treated with the copper phthalocyanine derivative, for the purpose of adjusting color tone of the ink. Examples of pigments that may be contained together include phthalocyanine blue pigments that are not treated as above, such as non-treated α-copper phthalocyanine (C. I. Pigment Blue 15), β-copper phthalocyanine (C. I. Pigment Blue 15:3) and ε-copper phthalocyanine (C. I. Pigment Blue 15:6); these phthalocyanine blue pigments treated with a surfactant or resin, etc.; carbon black, organic pigments such as azo based pigments, cyanine based pigments, dioxazine based pigments and quinacridone based pigments, inorganic pigments such as chromates, ferrocyanide compounds, metal oxides, sulfides, selenides, sulfates, silicates, carbonates, phosphates, metallic powders and pearlescent pigments, dyes such as oil soluble dyes and water soluble dyes, extender pigments such as precipitated barium sulfate, barium carbonate, chalk, gypsum, alumina white, clay, silica, silica white, talc, calcium silicate and precipitated magnesium carbonate, etc.

Pigments may be usually contained in the oil phase at a concentration of 30 wt % or less based on the total weight of the ink.

As the organic solvent of the oil phase, a paraffin oil is preferred, but organic solvents or naphthene oils normally used for letterpress printing, offset printing, screen printing and the like may also be used. Examples of the organic solvent include mineral oils such as liquid paraffin, spindle oil, light oil, kerosene oil, machine oil and lubricating oil; vegetable oils such as olive oil, rapeseed oil, castor oil and soybean oil; etc. Synthetic oils can also be used. Typical synthetic oils include polyisobutylenes, hydrogenated polydecenes, trimethylolpropane esters, neopentyl esters, pentaerythritol esters, di(2-ethylhexyl) sebacate, di(2-ethylhexyl) adipate, dibutylphthalate, fluorocarbons, silicon esters, silanes, esters of phosphorus-containing organic acids, liquid urea, ferrocene derivatives, hydrogenated synthetic oils, chained polyphenyls, siloxanes, silicones (polysiloxanes), alkyl substituted diphenyl ethers such as butyl substituted bis(p-phenoxyphenyl) ethers, phenoxyphenyl ethers and the like. These solvents can be used singly or in combination of two or more.

For the purpose of improving fixability of the ink onto paper, dispersibility of the pigment in the oil phase or the like, a resin can also be added to the oil phase. Examples of the resin include phenol resins, rosin modified phenol resins, maleic acid resins, petroleum resins, alkyd resins, rubber derivative resins, etc. These resins may be used singly or in combination of two or more. Among them, preferred are rosin modified phenol resins and alkyd resins, and especially preferred are alkyd resins. Preferably, the resin is added in an amount of 100 to 300 wt % based on the weight of the pigment.

The emulsifier is preferably a nonionic surfactant. Examples of the emulsifier include sorbitan higher fatty acid esters, polyoxyethylene sorbitan higher fatty acid esters, fatty acid monoglycerides, fatty acid diglycerides, ethylene oxide addition products of higher alcohols, alkyl phenols and fatty acids and the like. These can be used singly or in combination of two or more of them different in HLB value so as to prepare a highly stable emulsion.

Furthermore, as the evaporation preventive which may also be freeze preventive contained in the water phase, polyhydric alcohols such as ethylene glycol, sorbitol and glycerol, polyethylene glycol, or the like may be used.

Examples of the antiseptic and antifungal agent include aromatic hydroxy compounds and their chlorinated compounds, salicylic acid, phenolic acid, methyl p-hydroxybenzoate, ethyl p-hydroxybenzoate, sorbic acid, dehydroacetic acid and the like.

Examples of the water-soluble polymer used in the water phase include natural polymers such as starch, mannan, sodium alginate, galactan, tragacanth gum, gum arabic, pullulan, dextran, xanthane gum, glue, gelatin, collagen and casein; semi-synthetic polymers such as carboxymethyl cellulose, methyl cellulose, hydroxyethyl cellulose, hydroxypropyl cellulose, hydroxypropylmethyl cellulose, hydroxymethyl starch, carboxymethyl starch and dialdehyde starch; synthetic polymers such as acrylic acid resin, acrylic acid resin derivatives including sodium polyacrylate and polyacrylic acid triethanolamine, polyvinyl alcohol, polyvinyl pyrrolidone, polyacrylamide, polyethylene oxide and polyvinylmethyl ether and the like.

The stencil printing ink of the present invention can be produced according to known methods. For example, the oil phase can be produced by dispersing the pigment in a solvent using a known dispersing machine, and further diluting the dispersion with the solvent while other ingredients of the oil phase are optionally added thereto. For the dilution, a known stirrer can be used. The water phase can be produced by mixing and dissolving the ingredients of the water phase in water using a stirrer. Then, the water phase is added dropwise to the oil phase with stirring using a known emulsifying machine, to easily obtain a water-in-oil emulsion ink. Conditions of the dispersion, dilution and emulsification can be selected as required.

### EXAMPLES

The present invention is described below particularly in reference to examples, but is not limited thereto. In the following examples, “parts” and “%” mean “parts by weight” and “wt %”, respectively.

### Reference Example 1

### Treatment of Pigment

### Preparation of β-copper Phthalocyanine Pigment Treated with a Copper Phthalocyanine Derivative

Dried crude copper phthalocyanine was ground using an attritor, to obtain a mixture consisting of α-copper phthalocyanine and β-copper phthalocyanine.

The resultant mixture was immersed in a mixed solvent consisting of isopropyl alcohol and xylene, to be perfectly converted into β-crystal form, and dimethylamino copper phthalocyanine was added thereto for treatment. Then, the dispersion in which the treated pigment was dispersed was sprayed into hot air to dry instantaneously, yielding a β-copper phthalocyanine pigment treated with the copper phthalocyanine derivative {hereinafter this treated pigment is called “copper phthalocyanine derivative treated product (1)”}. Furthermore, the treatment was repeated in the same manner as above, except aminomethyl copper phthalocyanine was used instead of dimethylamino copper phthalocyanine, to obtain a β-copper phthalocyanine pigment treated with the copper phthalocyanine derivative (hereinafter this treated pigment is called “copper phthalocyanine derivative treated product (2)”). Moreover, the treatment was repeated in the same manner as above, except diethylamino copper phthalocyanine was used instead of dimethylamino copper phthalocyanine, to obtain a β-copper phthalocyanine pigment treated with the copper phthalocyanine derivative (hereinafter this treated pigment is called “copper phthalocyanine derivative treated product (3)”).

### Example 1

### Preparation of Oil Phase

The formulation of the oil phase was employed as shown in Table 1. The ingredients shown in Table 1 were kneaded together using a three-roll mill, and in succession, were mixed uniform using a stirrer to prepare an oil phase.

### Preparation of Water Phase

A water phase was obtained by mixing 0.01 part by weight of borax (available from Wako Pure Chemical Industries, Ltd.) with pure water.

### Preparation of Ink

An ink for stencil printing was obtained by adding 63.0 parts of the water phase to 37.0 parts of the oil phase so as to perform emulsification.

### Evaluation

The ink prepared as mentioned above was evaluated according to the following methods, in regard to storage stability, dispersibility and emulsification property. The results are shown in Table 3.

(1) Storage Stability

(a) 70 Degree C. Acceleration Test

The ink was stored under the condition of 70 degree C., and the viscosity of the ink was measured using a Visco-tester (available from Rion Co., Ltd.) (at 23 degree C.), and the viscosity rise rate was evaluated in reference to the following three-stage criterion.

o: Seven days later, the viscosity rise rate was less than 1.4 times.

Δ: Seven days later, the viscosity rise rate was 1.4 times to less than 2.0 times.

x: Seven days later, the viscosity rise rate was 2.0 times to less than 2.5 times.

(b) 50 Degree C. Acceleration Test

The ink was stored under the condition of 50 degree C., and the ink viscosity was measured using a Visco-tester (available from Rion Co., Ltd.) (at 23 degree C.), and the viscosity rise rate was evaluated in reference to the following three-stage criterion.

o: Fourteen days later, the viscosity rise rate was less than 1.4 times.

Δ: Fourteen days later, the viscosity rise rate was 1.4 times to less than 2.0 times.

x: Fourteen days later, the viscosity rise rate was 2.0 times to less than 2.5 times.

(c) Cycle Test

The ink was stored in a cycle tester, in which the temperature changed between 50 degree C. and −20 degree C. every 12 hours, and the viscosity of the ink was measured using a Visco-tester (available from Rion Co., Ltd.) (at 23 degree C.). The viscosity rise rate was evaluated in reference to the following three-stage criterion.

o: Fourteen days later, the viscosity rise rate was less than 1.4 times.

Δ: Fourteen days later, the viscosity rise rate was 1.4 times to less than 2.0 times.

x: Fourteen days later, the viscosity rise rate was 2.0 times to less than 2.5 times.

(2) Dispersibility

A three-roll mill (small type available from Inoue Manufacturing Co., Ltd.) was used to disperse the oil phase of the stencil printing ink three times. Then, roll seizure was visually observed after the first time of the dispersion of three times. A case where no seizure occurred at all is expressed by o; a case where any seizure occurred, by Δ; and a case where severe seizure occurred, by x.

(3) Emulsification Property

A vacuum emulsifying machine (small type available from Tokushu Kika Kogyo Co., Ltd.) was used for emulsifying the stencil printing ink. Then, aggregation of the pigment was observed. A case where no pigment aggregation occurred at all is expressed by o; a case where any pigment aggregation occurred, by Δ; and a case where severe pigment aggregation occurred, by x.

### Examples 2 to 8 and Comparative Examples 1 to 6

Inks for stencil printing were obtained and evaluated according to the same method as in Example 1, except that the chemical compositions as shown in Tables 1 and 2 were used. The results are shown in Table 3.

TABLE 1

| | | | Example | Example | Example | Example | Example | Example | Example | Example |
|---|---|---|---|---|---|---|---|---|---|---|
| | | | 1 | 2 | 3 | 4 | 5 | 6 | 7 | 8 |
| Oil | Pigment | Carbon black | — | — | — | 5.00 | — | 5.00 | — | — |
| Phase | | Quinacridone | — | — | — | — | — | — | 3.00 | 3.00 |
| | | Copper phthalocyanine | 5.00 | — | — | 1.00 | 5.00 | — | 3.00 | 1.00 |
| | | derivative treated product (1) | | | | | | | | |
| | | Copper phthalocyanine | — | 5.00 | — | — | — | 1.00 | — | — |
| | | derivative treated product (2) | | | | | | | | |
| | | Copper phthalocyanine | — | — | 5.00 | — | — | — | — | — |
| | | derivative treated product (3) | | | | | | | | |
| | | Non-surface-treated β-copper | — | — | — | — | — | — | — | 2.00 |
| | | phthalocyanine | | | | | | | | |
| | | Non-surface-treated α-copper | — | — | — | — | — | — | — | — |
| | | phthalocyanine | | | | | | | | |
| | Emulsifier | DG-60 | 2.00 | 2.00 | 2.00 | 2.00 | — | — | 2.00 | 2.00 |
| | | SP-O-8 | — | — | — | — | 2.00 | 2.00 | — | — |
| | Resin | Alkyd resin | 15.00 | 15.00 | 13.00 | 13.00 | 13.00 | 15.00 | 13.00 | 12.00 |
| | Solvent | AF-6 (available from Nippon | 15.00 | 15.00 | 15.00 | 14.00 | 20.00 | 15.00 | 15.00 | 15.00 |
| | | Oil Corp.) | | | | | | | | |

| | | | | | | | | |
|---|---|---|---|---|---|---|---|---|
| Water phase | 63.00 | 63.00 | 65.00 | 65.00 | 60.00 | 62.00 | 64.00 | 65.00 |
| Total | 100.00 | 100.00 | 100.00 | 100.00 | 100.00 | 100.00 | 100.00 | 100.00 |

Note:
DG-60: Decaglycerol 6 oleate (available from Nikkol)
SP-O-8: Rikemal 0-80 (available from Riken Vitamin Co., Ltd.)

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Oil | Pigment | Carbon black | — | — | — | 5.00 | 5.00 | — |
| Phase | | Quinacridone | — | — | — | — | — | 3.00 |
| | | Copper phthalocyanine | — | — | — | — | — | — |
| | | derivative treated product (1) | | | | | | |
| | | Copper phthalocyanine | — | — | — | — | — | — |
| | | derivative treated product (2) | | | | | | |
| | | Copper phthalocyanine | — | — | — | — | — | — |
| | | derivative treated product (3) | | | | | | |
| | | Non-surface-treated β-copper | 5.00 | — | 5.00 | 1.00 | — | 3.00 |
| | | phthalocyanine | | | | | | |
| | | Non-surface-treated α-copper | — | 5.00 | — | — | 1.00 | — |
| | | phthalocyanine | | | | | | |
| | Emulsifier | DG-60 | 2.00 | 2.00 | — | 2.00 | 2.00 | 2.00 |
| | | SP-O-8 | — | — | 2.00 | — | — | — |
| | Resin | Alkyd resin | 15.00 | 15.00 | 13.00 | 15.00 | 15.00 | 15.00 |
| | Solvent | AF-6 (available from Nippon | 14.00 | 15.00 | 18.00 | 15.00 | 12.00 | 12.00 |
| | | Oil Corp.) | | | | | | |

| | | | | | | |
|---|---|---|---|---|---|---|
| Water phase | 64.00 | 63.00 | 62.00 | 62.00 | 65.00 | 65.00 |
| Total | 100.00 | 100.00 | 100.00 | 100.00 | 100.00 | 100.00 |

Note:
DG-60: Decaglycerol 6 oleate (available from Nikkol)
SP-O-8: Rikemal 0-80 (available from Riken Vitamin Co., Ltd.)

TABLE 3

| | Storage stability | | | | |
|---|---|---|---|---|---|
| | 70 degree C. | 50 degree C. | | | Emulsi- |
| | acceleration | acceleration | Cycle | Dispers- | fication |
| | test | test | test | ibility | property |
| Example 1 | ◯ | ◯ | ◯ | ◯ | ◯ |
| Example 2 | ◯ | ◯ | ◯ | ◯ | ◯ |
| Example 3 | ◯ | ◯ | ◯ | ◯ | ◯ |
| Example 4 | ◯ | ◯ | ◯ | ◯ | ◯ |
| Example 5 | ◯ | ◯ | ◯ | ◯ | ◯ |
| Example 6 | ◯ | ◯ | ◯ | ◯ | ◯ |
| Example 7 | ◯ | ◯ | ◯ | ◯ | ◯ |
| Example 8 | ◯ | ◯ | ◯ | ◯ | ◯ |
| Comparative | Δ | Δ | X | X | X |
| Example 1 | | | | | |
| Comparative | Δ | Δ | X | X | X |
| Example 2 | | | | | |
| Comparative | X | Δ | X | Δ | X |
| Example 3 | | | | | |
| Comparative | Δ | ◯ | Δ | Δ | Δ |
| Example 4 | | | | | |
| Comparative | Δ | ◯ | X | Δ | Δ |
| Example 5 | | | | | |
| Comparative | Δ | ◯ | Δ | Δ | Δ |
| Example 6 | | | | | |

From the results shown in Table 3, the following can be seen. The inks of Examples 1 to 8, in which copper phthalocyanine pigments treated with copper phthalocyanine derivatives represented by the general formula (I) were used as pigments, are excellent in storage stability, dispersibility and emulsification property. On the other hand, the inks of Comparative Examples 1 to 6, in which non-surface-treated copper phthalocyanine pigments were used, are inferior to those of the Examples in at least one of the properties.

The emulsion ink for stencil printing of this invention is good in pigment dispersibility, free from pigment aggregation at the time of emulsification and excellent in emulsion stability during storage since it contains, as a pigment, a copper phthalocyanine pigment treated with a specific copper phthalocyanine derivative.

1. An ink for stencil printing, comprising a water-in-oil emulsion having 10 to 50 wt % of an oil phase and 90 to 50 wt % of a water phase,
wherein the oil phase contains, as a pigment, at least a copper phthalocyanine pigment treated with a copper phthalocyanine derivative represented by the following general formula (I): 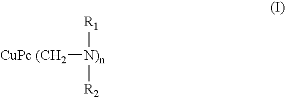
wherein CuPc represents a copper phthalocyanine residue; R₁ and R₂ independently represent a hydrogen atom, alkyl group with 1 to 5 carbon atoms, alkoxyalkyl group with 3 to 6 carbon atoms, or cycloalkyl group with 6 to 8 carbon atoms; and n is an integer of 1 to 6).

2. An ink for stencil printing according to claim 1, wherein the copper phthalocyanine pigment treated with the copper phthalocyanine derivative is contained at a concentration of 0.5 wt % or more based on the total weight of the ink.

3. An ink for stencil printing according to claim 1 or 2, wherein the particle size of the primary particles of the copper phthalocyanine pigment treated with the copper phthalocyanine derivative is within a range of 40 to 360 nm.

4. An ink for stencil printing according to claim 1, wherein the copper phthalocyanine pigment is treated with the copper phthalocyanine derivative in an amount of 0.01 to 50 wt % based on the copper phthalocyanine pigment.

5. An ink for stencil printing according to claim 4, wherein the copper phthalocyanine pigment is treated with the copper phthalocyanine derivative in an amount of about 2 to 20 wt % based the copper phthalocyanine pigment.
